(19) United States
(12) Patent Application Publication
(10) Pub. No.: US 2020/0039303 A1
(43) Pub. Date: Feb. 6, 2020

(54) Tire Inflator

(71) Applicant: Keith Thornton, Senoia, GA (US)

(72) Inventor: Keith Thornton, Senoia, GA (US)

(21) Appl. No.: 16/506,953

(22) Filed: Jul. 9, 2019

Related U.S. Application Data
(60) Provisional application No. 62/830,042, filed on Apr. 5, 2019.
(60) Provisional application No. 62/772,400, filed on Nov. 28, 2018.
(60) Provisional application No. 62/695,434, filed on Jul. 9, 2018.

(51) Int. Cl. B60C 23/12; F04B 35/01

(52) U.S. Cl. CPC B60C 23/12; F04B 35/01

(57) ABSTRACT

Systems and methods for inflating a tire are described herein. The systems and methods use a centrifugal force acting on a piston or the inertia of the piston to compress air to inflate the tire. Compressed air is ported into the tire, maintaining the pressure of the tire.

### CROSS REFERENCE TO RELATED APPLICATIONS

This application claims the benefit of co-pending U.S. Provisional Application No. 62/830,042 filed Apr. 5, 2019, entitled “Tire Inflator,” U.S. Provisional Application No. 62/772,400 filed Nov. 28, 2018, entitled “Tire Inflator,” and U.S. Provisional Application No. 62/695,434 filed Jul. 9, 2018, entitled “Tire Inflator,” all of which are incorporated herein by reference in their entirety.

### BACKGROUND

Underinflated tires can cause various issues. If tire pressure is too low, too much of the tire's surface area touches the road, which increases friction. Increased friction can cause the tires to overheat, which can lead to premature wear, tread separation and blowouts. Blowouts can put the driver of the vehicle with the damaged tire as well as other drivers in harm's way. A blowout could cause the driver to lose control of his vehicle and crash. Depending on the severity of the blowout, other drivers might swerve to avoid pieces of flying debris from the blown tire and crash their vehicles.

It is with respect to these and other considerations that the disclosure made herein is presented.

### SUMMARY

Technologies are described herein for a sling pump to be used as a tire inflator. In some examples, the sling pump includes an apparatus in fluidic communication with a tire of a vehicle. The apparatus is designed so that the centrifugal force of a rotating tire is used to generate a stored source of pressurized air. When the speed of rotation of the tire is reduced, the apparatus releases the pressured into to the tire to inflate the tire. In some examples, the apparatus includes a cylinder, a piston, and a spring. As the tire begins its rotation, the piston in the cylinder is moved towards a “compression” position due to the centrifugal force acting on the piston. As the piston moves towards the compression position, the air inside the cylinder is compressed by the piston, resulting in a pressurized air source. As the pressure increases above the pressure in the tire, a check value opens and releases the pressurized air enters the tire. As the tire slows down, the spring acts on the piston, moving the piston back to a “rest” position. The increase and decrease of the rotational speed of the tire causes the piston to move between the rest position and the compression position, inflating the tire.

This Summary is provided to introduce a selection of technologies in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is an illustration showing the operation of an example tire inflator system.

FIG. 2 is an illustration of an alternate tire inflator system in which a portion of the tire inflator system is installed internal to a wheel and a tire.

FIG. 3 is an illustration of a still further tire inflator system using a Schrader-type valve.

FIG. 4 is an illustration of an alternate tire inflator system using a tube to direct air into the tire.

FIG. 5 is an illustration of a further alternate tire inflator system in which sling pumps are mounted to a wheel at a location other than the rim of the wheel.

FIG. 6 is an illustration of a still further alternate tire inflator system in which the inertia of a piston is used to compress air.

### DETAILED DESCRIPTION

The following detailed description is directed to technologies for a sling pump to be used as a tire inflator. As used herein, a “tire inflator” and “sling pump” may be used interchangeably. While the presently disclosed subject matter may be described with respect to what is termed as examples, embodiments, and the like, it is understood that the presently disclosed tire inflator is not limited to the disclosed embodiments. Furthermore, it is understood that this invention is not limited to the particular methodology, materials, and modifications described and as such may, of course, vary. It is also understood that the terminology used herein is for the purpose of describing particular embodiments only, and, is not intended to limit the scope of the present invention. Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

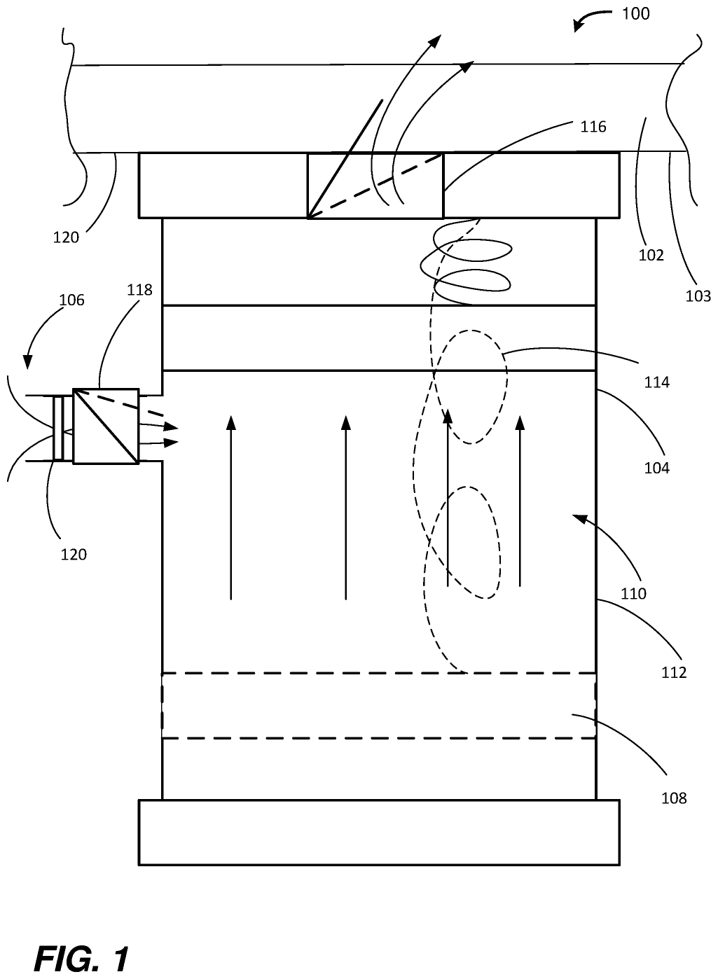

FIG. 1 is an illustration showing the operation of an example tire inflator system 100. The tire inflator system 100 includes a wheel 102. The wheel 102 is used to support a tire (not shown) for mounting to a vehicle (not shown). The wheel 102 is designed to rotate about the hub or other mechanism of a vehicle. Also illustrated in FIG. 1 is a sling pump 104 mounted to a rim 103 of the wheel. The sling pump 104 is the mechanism that pumps air 106 from the environment into the wheel 102 to inflate, at least partially, a tire or maintain a pressure of the tire.

The sling pump 104 uses the centrifugal force on piston 108 to force the air 106 into the wheel 102. In FIG. 1, the location of the various parts shown by dashed lines are considered to be the “charged” position, whereby the air 106 is charged into an inner volume 110 of a cylinder 112 that houses the piston 106. In FIG. 1, the location of the various parts shown by solid lines are considered to be the “pumping” position, whereby the air 106 that was charged into the inner volume 110 of the cylinder 112 is exhausted into the wheel 102, inflating a tire mounted on the wheel 102.

When the wheel 102 is not rotating, a spring 114 mounted internally to the inner volume 110 of the cylinder 112 of the sling pump 104 expands and moves the piston 108 from the pumping position to the charged position. A wheel check valve 116 closes because of a slight vacuum created when the piston 108 is forced from the pumping position to the charged position. In some examples, the wheel check valve 116 may have an internal biasing spring (not shown) that forces the check valve closed even if the wheel is spinning. For example, the piston 108 may have pushed all the air 106 into the wheel 102 during a pumping cycle. The wheel check valve 116 may close as soon as the pressure in the inner volume 110 equalizes with that of the tire. The wheel check valve 116 may also be configured to close even prior to the pressure the equalization of the pressure in the inner volume 110 and the pressure in the tire. The wheel check valve 116 is an air exhaust into the wheel or tire.

When the piston 108 is forced into the charged position by the spring 114, an air inlet check valve 118 opens, allowing the piston 108 to pull the air 106 from the environment into the inner volume 110 of the cylinder 112. As with the wheel check valve 116, the air inlet check valve 118 may have a biasing spring (or other mechanism) to alter the behavior of the air inlet check valve 118. In some examples, a filter 120 may be used to filter (or clean) the air 106 prior to the introduction of the air 106 into the inner volume 110 of the cylinder 112.

When the wheel 102 begins to rotate, a centrifugal force will start acting on the piston 108, forcing the piston 108 outwards (shown by the arrows in the inner volume 110. The reason for this is that by being attached to the inner surface 122 of the wheel 102 (the surface closest in proximity to the hub or rotational center of the wheel/tire combination), when the wheel 102 rotates, the centrifugal force will be directed outwards, pushing the piston 108 in the direction from the charged position to the pumping position. When this occurs, the air inlet check valve 118 is closed and, if the centrifugal force on the piston 108 is enough to overcome the spring 114, any biasing on the wheel check valve 116, and any differential pressure between the tire and the air pressure in the inner volume 110, the wheel check valve 116 will open, causing the air 106 charged into the inner volume 110 to be pumped into the wheel through the wheel check valve 116.

When equalized or at a pressure configured by any biasing that may be present in the wheel check valve 116, the wheel check valve 116 closes. When the wheel 102 reduces its rotation to a certain speed, the reduction in the centrifugal force acting on the piston 108 in combination with the force of the spring 114 causes the piston 108 to be pushed back to the charged position (illustrated by dashed lines).

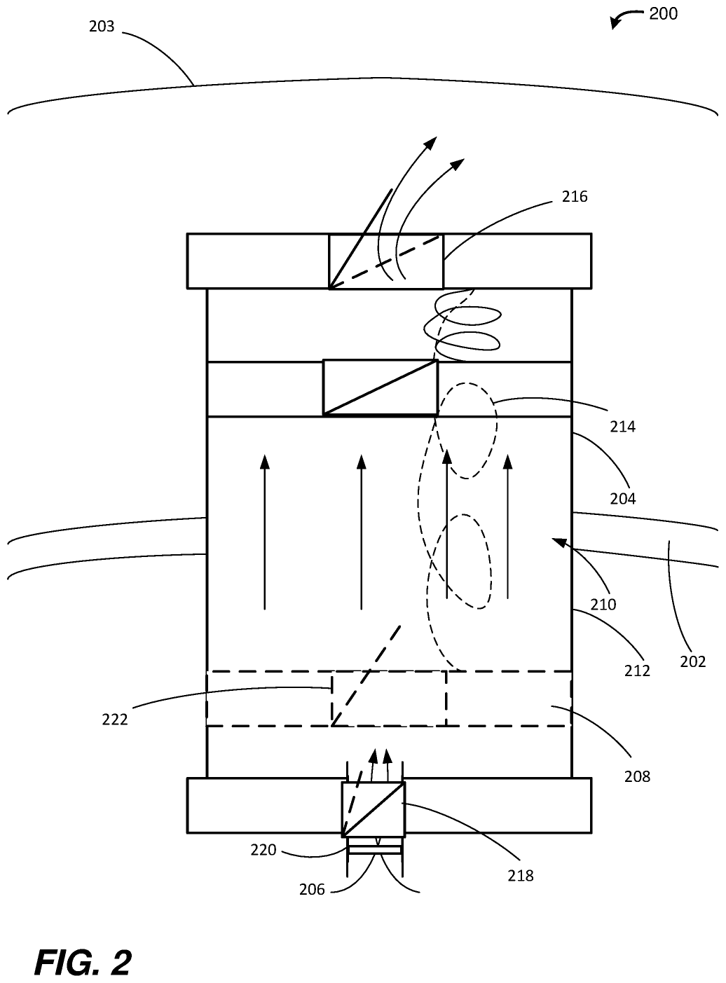

FIG. 2 is an illustration of an alternate tire inflator system 200 in which a portion of the tire inflator system 200 is installed internal to a wheel 202 and a tire 203. The wheel 202 is used to support the tire 203 for mounting to a vehicle (not shown). The wheel 202 is designed to rotate about the hub or other mechanism of a vehicle. Also illustrated in FIG. 2 is a sling pump 204. The sling pump 204 is the mechanism that pumps air 206 from the environment into the wheel 202 to inflate, at least partially, the tire 203 or maintain a pressure of the tire. The sling pump 204 includes a cylinder 212 with an inner volume 210.

The sling pump 204 uses the centrifugal force on piston 208 to force the air 206 into the wheel 202. In FIG. 2, the location of the various parts shown by dashed lines are considered to be the “charged” position, whereby the air 206 is charged into the inner volume 210 of a cylinder 112 that houses the piston 206. In FIG. 2, the location of the various parts shown by solid lines are considered to be the “pumping” position, whereby the air 206 that was charged into the inner volume 210 of the cylinder 212 is exhausted into the wheel 202, inflating the tire 203 mounted on the wheel 202.

When the wheel 202 is not rotating, a spring 214 mounted internally to the inner volume 210 of the cylinder 212 of the sling pump 204 expands and moves the piston 208 from the pumping position to the charged position. A wheel check valve 216 closes because of a slight vacuum created when the piston 208 is forced from the pumping position to the charged position. In some examples, the wheel check valve 216 may have an internal biasing spring (not shown) that forces the check valve closed even if the wheel is spinning. For example, the piston 208 may have pushed all the air 206 into the wheel 202 during a pumping cycle. The wheel check valve 216 may close as soon as the pressure in the inner volume 210 equalizes with that of the tire 203. The wheel check valve 216 may also be configured to close even prior to the pressure the equalization of the pressure in the inner volume 210 and the pressure in the tire 203.

When the piston 208 is forced into the charged position by the spring 214, an air inlet check valve 218 opens, allowing the piston 208 to pull the air 206 from the environment into the inner volume 210 of the cylinder 212. As with the wheel check valve 216, the air inlet check valve 218 may have a biasing spring (or other mechanism) to alter the behavior of the air inlet check valve 218. In some examples, a filter 220 may be used to filter (or clean) the air 206 prior to the introduction of the air 206 into the inner volume 210 of the cylinder 212.

When the wheel 202 begins to rotate, a centrifugal force will start acting on the piston 208, forcing the piston 208 outwards (shown by the arrows in the inner volume 210. The reason for this is that by being attached to the inner surface 222 of the wheel 202 (the surface closest in proximity to the hub or rotational center of the wheel/tire combination), when the wheel 202 rotates, the centrifugal force will be directed outwards, pushing the piston 208 in the direction from the charged position to the pumping position. When this occurs, the air inlet check valve 218 is closed and, if the centrifugal force on the piston 208 is enough to overcome the spring 214, any biasing on the wheel check valve 216, and any differential pressure between the tire and the air pressure in the inner volume 210, the wheel check valve 216 will open, causing the air 206 charged into the inner volume 210 to be pumped into the wheel through the wheel check valve 216.

When equalized or at a pressure configured by any biasing that may be present in the wheel check valve 216, the wheel check valve 216 closes. When the wheel 202 reduces its rotation to a certain speed, the reduction in the centrifugal force acting on the piston 108 in combination with the force of the spring 214 causes the piston 208 to be pushed back to the charged position (illustrated by dashed lines).

To allow the air 206 to enter the inner volume 210, the piston 208 has a piston check valve 222. The piston check valve 222 is configured to be open when the piston 208 is moving from the pumping position (shown by solid lines) to the charging position (shown by dashed lines). The piston check valve 222 is configured to be closed when the piston 208 is moving from the charged position (shown by dashed lines) to the pumping position (shown by solid lines).

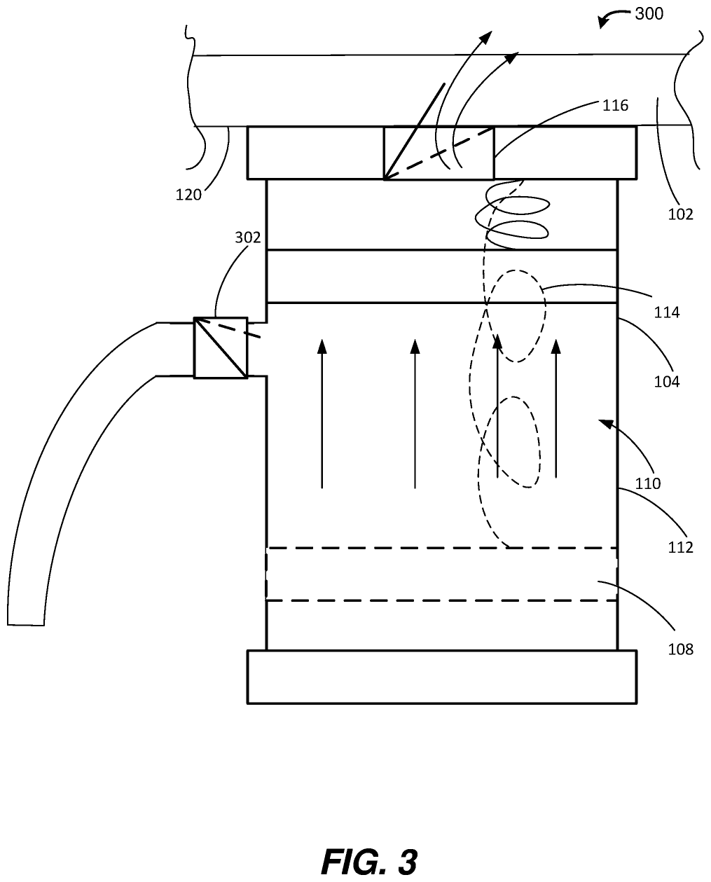

FIG. 3 is an illustration of an alternate tire inflator system 300. The tire inflator system 300 replaces the air inlet valve 118 of FIG. 1 with a Schrader-type air valve 302. A Schrader-type air valve 302 is a valve that can be used to connect to an air pressure source such as a compressor. The remaining components of the tire inflator system 300 can use components as described in FIG. 1, including its operation.

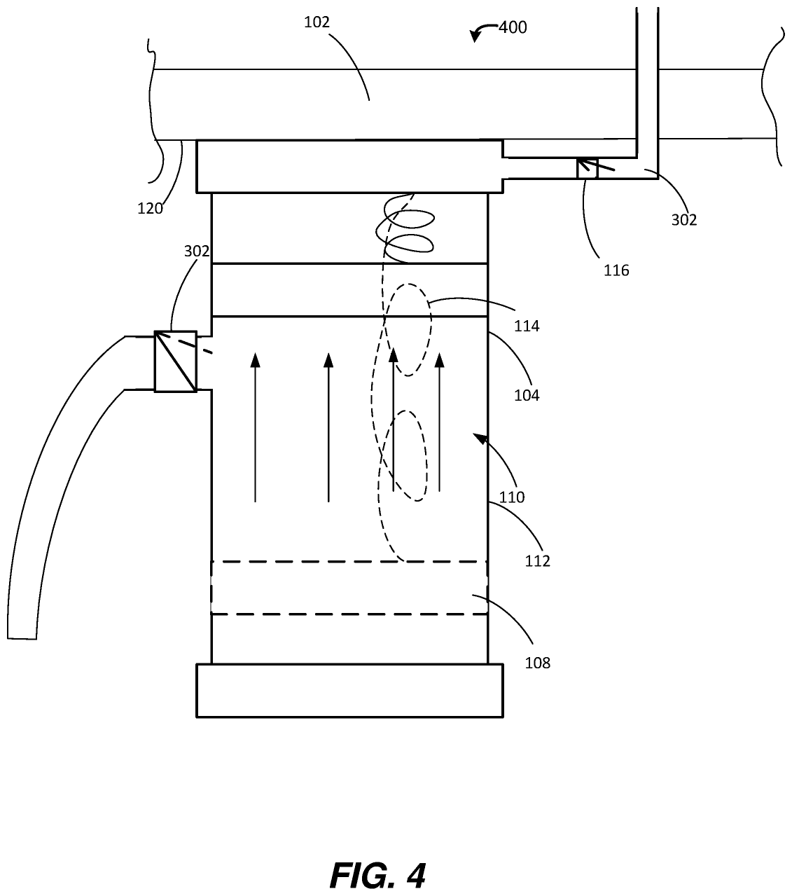

FIG. 4 is an illustration of an alternate tire inflator system 400. The tire inflator system 400 uses tube 402 to direct the air 106 into the wheel 102 at a location different than where the piston 104 is mounted to the wheel 102. The remaining components of the tire inflator system 300 can use components as described in FIG. 1, including its operation.

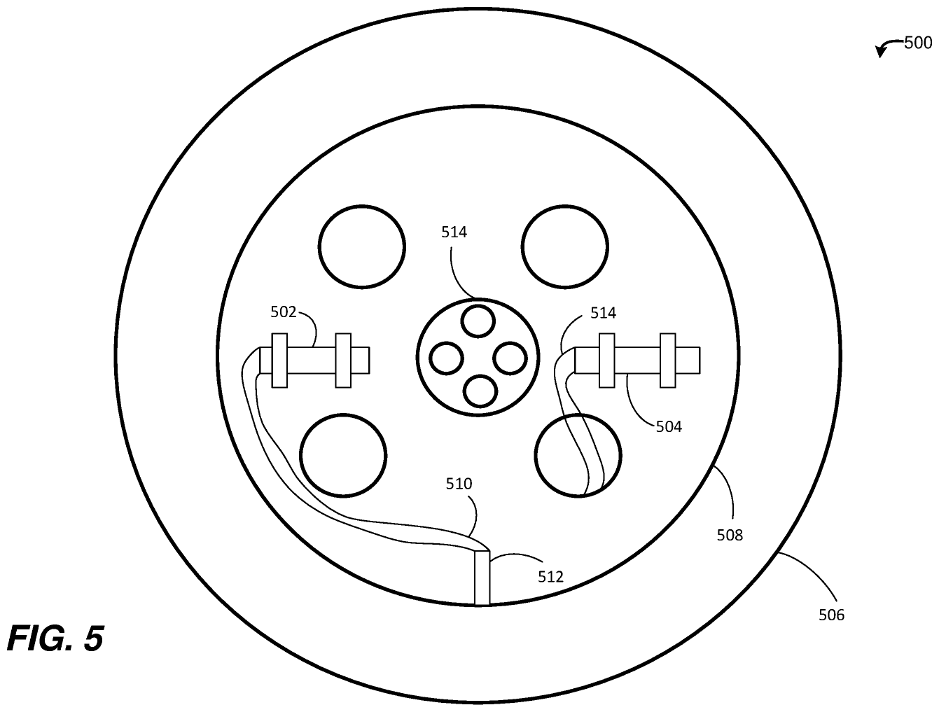

FIG. 5 is an illustration of a further alternate tire inflator system 500. The tire inflator system 500 includes sling pumps 502 and 504, which may be constructed in a manner similar to the sling pumps of FIGS. 1-4, whereby centrifugal force is used to pump air into a tire 506 mounted on a wheel 508. The sling pumps 502 and 504 are mounted proximate to a hub 507 of the wheel 508 rather than a rim. In FIG. 5, the air pumped into the tire 506 is directed through tube 510 from the sling pump 502 through stem valve 512. The sling pump 504 directs the air from the sling pump 504 through tube 514 to an inner tire (not shown). As with other sling pumps described above, centrifugal force is used to compress air in the sling pumps 502 into the tire 506.

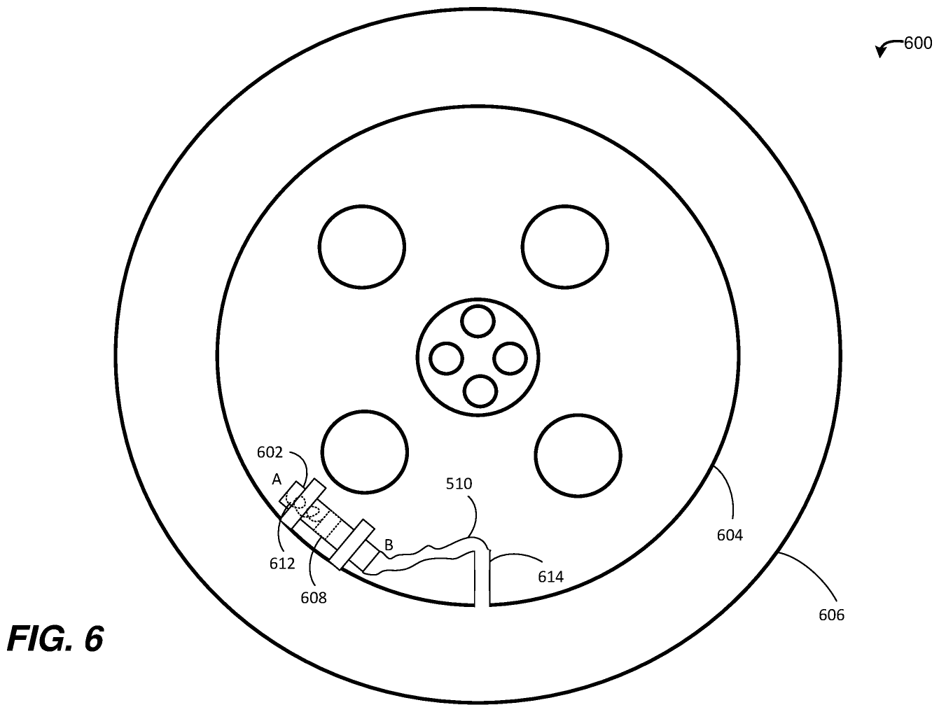

FIG. 6 is an illustration of a still further alternate tire inflator system 600. In FIG. 6, a sling pump 602 is mounted onto the wheel 604 in a parallel configuration to the tire 606 and the wheel 604. If the sling pump 602 is mounted parallel to the wheel 604, rather than centrifugal force acting on a piston 608 to move the piston 608, the inertia of the piston 608 can be used to move the piston (with the remaining operation similar to those of FIGS. 1-5 above). When the tire 606 begins its rotation, the sling pump 602 begins its rotation as well because the sling pump 602 is affixed to the wheel 604. However, the piston 608 is movably mounted inside the sling pump 602 (similar to the piston 108 of FIG. 1 and other internal components of the sling pump 104). When the sling pump 602 begins to move, the piston 608 will not initially move due to inertia, resulting in the piston 608 moving towards the top of the stroke to location A against the force of spring 612, charging air into the sling pump 602. When the tire 606 slows, the pressure of the spring 612 pushes the piston towards location B, which compresses the air in the sling pump 602 into the tire 606 through tire valve 614.

Other variations can include the following, but are not limited to the following:

If used as 1 unit by using balance weight 180 degrees from installation location or in pairs spaced 180 degrees apart. Sling pump is installed through hole on customized wheel. Mounting hole is placed in wheel 90 degrees from the valve steam, balance weight or other the sling pump is placed 180 degrees from this location.

The sling pump can be installed with the majority of the sling pump inside the tire (Tire Mount) (as on smaller diameter wheels), the body of the sling pump toward the center of the wheel (Wheel Mount) (larger diameter wheels) or Body mount through the rim where the sling pump extends inside and outside the tire.

Sling pump is configured to where the capacity of pressure that the sling pump can produce is the recommended pressure of the tire by the volume of air compressed. This can be limited by the stroke of the piston.

Some additional details of the sling pump include:

Piston assembly: Wear ring goes in lower ring groove (opposite check valve) compression ring goes in upper groove nearest check valve. Check valve is installed using tool provided by manufacturer (small diameter rod with rounded end) The sling pump easily presses into center hole on valve seat locking into place.

Cylinder Assembly: Check valve is installed into valve seat (same check valve as used on piston) if unit is being used inside tire (Tire Mount), if being used with cylinder toward center of wheel (Wheel mount), no assembly required.

Final assembly: Piston assembly is slid into the bore with the check valve end going in 1^{st} if unit is going to be used inside tire (Tire Mount). Opposite if being used with cylinder toward wheel. (Wheel Mount). Tail port is installed (with check valve if wheel mount)

Mounting: Tire Mount or Wheel Mount: Tire is placed on wheel, not seated at bead. Sling pump is installed inside of tire (Check valve toward tire) and secured in place. Tire is seated as normal.

Some examples of the presently disclosed subject matter may be used in conjunction with a Schrader valve or a modified Schrader valve. In some examples, a wheel manufacturer or customer may want to maintain a single entry point through a wheel. Typically, the single entry point is where a valve stem of a Schrader valve extends from the inner part of the wheel (that receives air to be pressured) to the outer part of the wheel (from which air is pumped to pressurize the inner part of the wheel). In some examples, the inner part of the wheel may include a rubber tube inside a tire. However, other examples may include tubeless tire designs and are also considered to be within the scope of the presently disclosed subject matter.

Based on the foregoing, it should be appreciated that technologies for a sling pump have been disclosed herein. It is to be understood that the invention defined in the appended claims is not necessarily limited to the specific features or acts described herein. Rather, the specific features or acts are disclosed as example forms of implementing the claims.

The subject matter described above is provided by way of illustration only and should not be construed as limiting. Various modifications and changes can be made to the subject matter described herein without following the example configurations and applications illustrated and described, and without departing from the true spirit and scope of the present invention, aspects of which are set forth in the following claims.

What is claimed is:

1. A sling pump for inflating a tire, the sling pump comprising:
a cylinder;
a piston mounted internal to the cylinder;
an air intake designed to receive air from the environment around the sling pump;
an air exhaust to exhaust compressed air in the cylinder into the tire; and
a spring,
wherein the piston is configured to move a pumping position when centrifugal force acting on the piston is greater than the force of the spring and to a charged position when centrifugal force acting on the piston is less than the force of the spring, and wherein a movement of the piston to the pumping position pumps air into the tire and a movement of the piston to the charging position pulls air into the cylinder.

2. The sling pump of claim 1, wherein the cylinder is mounted externally to a wheel onto which the tire is mounted.

3. The sling pump of claim 1, wherein the cylinder is mounted internally to a wheel onto which the tire is mounted.

4. The sling pump of claim 1, wherein the cylinder is mounted partially internally and partially externally to a wheel onto which the tire is mounted.

5. The sling pump of claim 1, wherein the air inlet comprises a Schrader-type valve.

6. The sling pump of claim 1, wherein the air exhaust comprises a tube to allow the air compressed by the piston into the tire.

7. The sling pump of claim 1, wherein the cylinder is mounted to a rim of a wheel onto which the tire is mounted.

8. The sling pump of claim 1, wherein the cylinder is mounted proximate to a hub of a wheel onto which the tire is mounted.
